(19) United States
(12) Patent Application Publication
(10) Pub. No.: US 2016/0352803 A1
(43) Pub. Date: Dec. 1, 2016

(54) RECONSTRUCTION OF WEB PAGES BASED ON DOM SERIALIZATION

(71) Applicant: FIREGLASS LTD., Tel Aviv (IL)

(72) Inventors: DAN AMIGA, HERZLIYA (IL); GUY GUZNER, TEL AVIV (IL)

(21) Appl. No.: 15/164,997

(22) Filed: May 26, 2016

Related U.S. Application Data
(60) Provisional application No. 62/167,473, filed on May 28, 2015.

(51) Int. Cl. H04L 29/08; H04L 29/06

(52) U.S. Cl. CPC H04L 67/02; H04L 67/42; H04L 67/28

(57) ABSTRACT

Processing a web page by receiving from a client software application a request to retrieve a web page, processing the web page at a surrogate software application, thereby representing the web page in a model that is maintained by the surrogate software application in association with the web page, serializing a copy of any portion of the model that is maintained by the surrogate software application, thereby creating serialized data, and sending the serialized data to a mediation agent executed by the client software application, where the mediation agent is configured to deserialize the serialized data, thereby creating deserialized data, and inject the deserialized data into a model that is maintained by the client software application in association with the web page.

### CROSS-REFERENCE TO RELATED APPLICATIONS

This application claims the benefit of U.S. Provisional Application No. 62/167,473, filed May 28, 2015, the disclosure of which is incorporated herein by reference in its entirety.

### BACKGROUND

Computer malware is often downloaded by computers in the form of scripts (e.g., Javascript™, VBScript™) and plugins (e.g., Java™, Flash™) that are executed by web browsers on user computers. Techniques that prevent downloaded code from being executed on user computers, and thereby prevent the execution of such malware on user computers, but that do so without negatively affecting the end-user experience, would be advantageous.

### SUMMARY

In one aspect of the invention a method is provided for processing a web page, the method including receiving from a client software application a request to retrieve a web page, processing the web page at a surrogate software application, thereby representing the web page in a model that is maintained by the surrogate software application in association with the web page, serializing a copy of any portion of the model that is maintained by the surrogate software application, thereby creating serialized data, and sending the serialized data to a mediation agent executed by the client software application, where the mediation agent is configured to deserialize the serialized data, thereby creating deserialized data, and inject the deserialized data into a model that is maintained by the client software application in association with the web page.

In other aspects of the invention systems and computer program products embodying the invention are provided.

### BRIEF DESCRIPTION OF THE DRAWINGS

Aspects of the invention will be understood and appreciated more fully from the following detailed description taken in conjunction with the appended drawings in which:

FIG. 1 is a simplified conceptual illustration of a system for processing a web page, constructed and operative in accordance with an embodiment of the invention;

FIGS. 2, 3, 4, and 5 are exemplary code samples useful in understanding embodiments of the invention; and

FIGS. 6, 7, 8, 9, 10, and 11 are simplified flowchart illustrations of exemplary methods of operation of the system of FIG. 1, operative in accordance with embodiments of the invention.

### DETAILED DESCRIPTION

Embodiments of the invention may include a system, a method, and/or a computer program product. The computer program product may include a computer readable storage medium (or media) having computer readable program instructions thereon for causing a processor to carry out aspects of the invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java™, Smalltalk™, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the invention.

Aspects of the invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

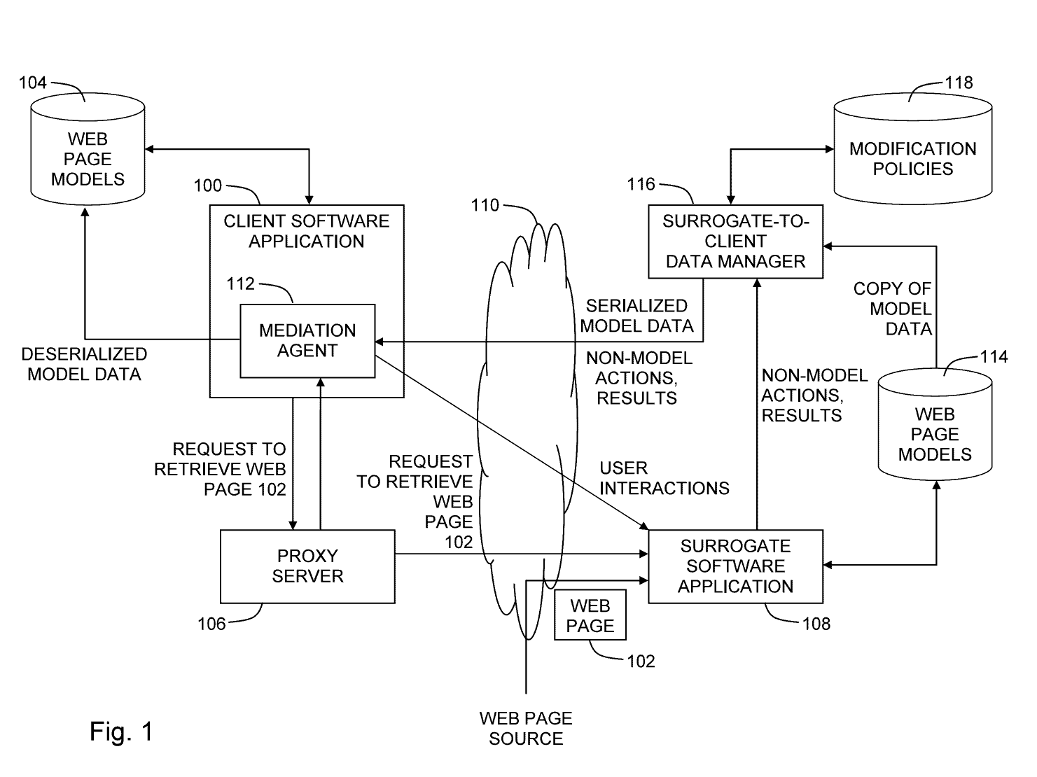

Reference is now made to FIG. 1, which is a simplified conceptual illustration of a system for processing a web page, constructed and operative in accordance with an embodiment of the invention. In the system of FIG. 1, a client software application 100 is shown, which may be a web browser such as Google Chrome™, Apple Safari™, or any other software application capable of rendering a web page, such as a web page 102, including webkit.org's WebKit™ or chromium.org's Blink™, where client software application 100 constructs and maintains one or more models 104 in association with web page 102, such as a document object model (DOM) and a cascading style sheet object model (CSSOM), in accordance with conventional techniques. Requests by client software application 100 to retrieve web pages and other web-based resources are mediated by a proxy server 106 that is configured to selectably forward such requests by client software application 100 to a surrogate software application 108, such as via a computer network 110, which may be an intranet or a publicly-accessible computer network, such as the Internet. Proxy server 106 is preferably configured to provide a mediation agent 112 to client software application 100 at the start of any given communications session between client software application 100 and proxy server 106, such as in response to client software application 100 requesting to retrieve web page 102. As such, mediation agent 112 is not pre-installed with client software application 100 or its host computer. Mediation agent 112, which may, for example, be implemented in Javascript™ code, is preferably configured to create a logical persistent connection between client software application 100 and surrogate software application 108 in accordance with conventional techniques, such as by employing the Long Pooling HTTP/S technique or WebSocket (WS:// or WSS://) protocol of Transport Control Protocol (TCP) sockets, where the persistent connection is used for communications with client software application 100 as described below. Mediation agent 112

Surrogate software application 108 is configured to operate as a web browser to retrieve and render web pages and other web-based resources that are requested by client software application 100, where such requests are forwarded by proxy server 106 to surrogate software application 108. Surrogate software application 108 is also configured to construct and maintain one or more models 114, such as a DOM and a CSSOM, in association with a retrieved web page, such as web page 102, in accordance with conventional techniques. One or more instances of surrogate software application 108 may be provisioned, where mediation agent 112 can choose to interact with one or more of the instances.

A surrogate-to-client data manager 116 is configured to serialize, in accordance with conventional techniques, a copy of any of models 114, or of any portion thereof, associated with web page 102, and send the serialized data to mediation agent 112. Surrogate-to-client data manager 116 is also preferably configured to modify, in accordance with one or more predefined modification policies 118, any portion of the copy of models 114 and to include such modifications in the serialized data that are sent to mediation agent 112. For example, the DOM representation of the following web page code:

<div id=″content_div″ onclick=”javascript:runThisFunction( )”>
<img src=″http://www.facebok.com/images/welcome.gif″/>
</div>

may be modified to eliminate the ‘onclick’ attribute, such as in accordance with a predefined security policy, and serialized as follows:

```
{
    action : ‘insert’,
    location : ‘parent_id’,
    content : {
    ‘tag’ : ‘div’,
    attributes : {
        ‘id’ : ‘content_div’
    },
    children : [{
        tag : ‘img’,
        attributes : {
            src=‘http://www.facebook.com/images/welcome.gif’
        }
    }]
}
```

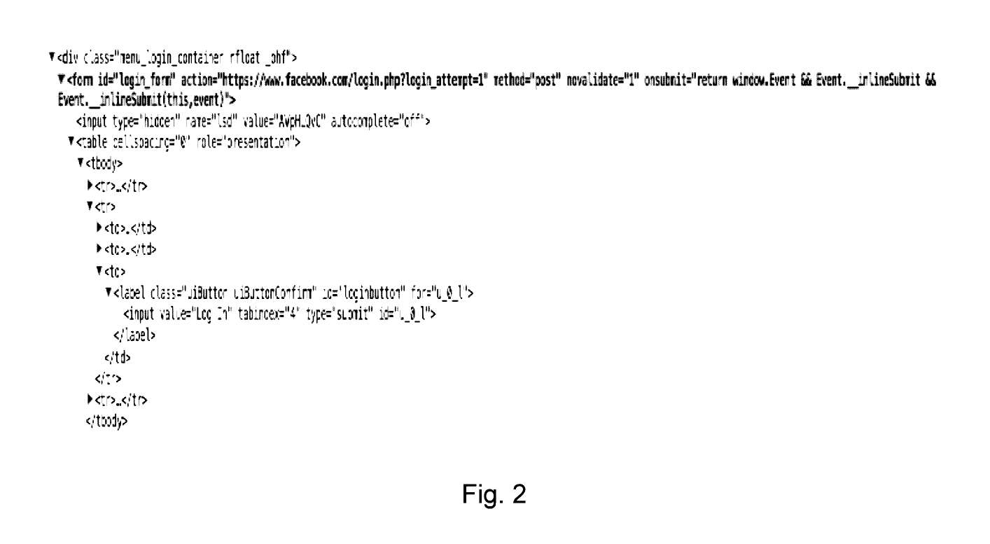

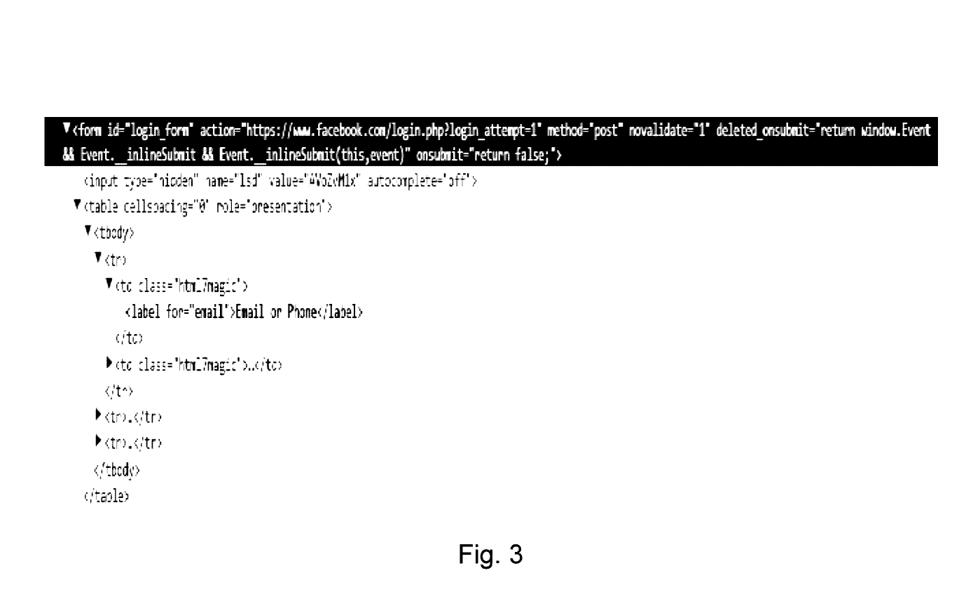

In various embodiments, surrogate-to-client data manager 116 is configured to perform any of the following modifications, among other possible types of modifications, on copies of data from models 114 prior to serializing and sending the data to mediation agent 112:
Adding or removing an HTML element or attribute;
Changing an HTML element or attribute;
Assigning a custom ID (e.g. unique_id attribute) to each element in order to effectively identify it;
Removing or commenting-out all <SCRIPT> tags;
Replacing SRC attribute uniform resource locators with uniform resource locators of copies of the SRC-indicated resources that are stored in locations that are under the control of surrogate software application 108 and/or that are known to have been checked for the presence of malware or that have been sanitized;
Sanitizing data using methods such as ‘format’ conversion (e.g. JPEG to PNG to JPEG for images);
Replacing SRC attribute uniform resource locators with base64 data-encoded representations of the SRC-indicated resources, such as where <img src=http://www.facebook.com/image.png/> is encoded as data:[<MIME-type>][;charset=<encoding>][;base64],<data> resulting in <img src=“data:image/png;base64,iVBORw0KGgoAAAANSUhEUgAAAAUAAAAFCAYAAACNbyb1AAAAHElEQVQI12P4//8/w38GIAXDIBKEODHxgljNBAAO9TXL0Y4OHwAAAABJRU5ErkJggg==”/>;
Modifying SRC attributes to include a predefined indicator known to proxy server 106 whose presence causes proxy server 106 to query surrogate software application 108 for the SRC-indicated resources;
Modifying SRC attribute uniform resource locators of predefined or administrator-defined “safe” resources, such as YouTube™ videos, to include a predefined indicator known to proxy server 106 whose presence causes proxy server 106 to retrieve the SRC-indicated resources from their specified locations;
Modifying HTML FORM elements to prevent client software application 100 from submitting HTML forms directly, such as by replacing ‘onsubmit’ handlers with ‘deleted_onsubmit’ handlers that return ‘false’, such as in the example shown in FIG. 2, where a copy of the associated web page DOM maintained by surrogate software application 108 representing the HTML form shown in FIG. 2 is modified as shown in FIG. 3, where the modified version is injected into the corresponding associated web page DOM maintained by client software application 100.

Mediation agent 112 is configured to deserialize the received serialized data received from surrogate-to-client data manager 116 in association with web page 102 and inject the deserialized data into models 104 that are maintained by client software application 100, preferably within its own memory address space, in association with web page 102. For example, deserialized data may be injected into models 104 using Javascript™ methods such as document.createComment, document.createTextNode, document.createDocumentType, and document.createElement, and placed in the correct locations using methods such as appendChild and insertBefore.

Surrogate software application 108 is also preferably configured to monitor models 114 in accordance with conventional techniques to identify changes, including additions, deletions, and modifications, that are made to models 114 by surrogate software application 108 in association with web page 102, whereupon surrogate-to-client data manager 116 periodically serializes and sends such changes to mediation agent 112. In one embodiment, a mutation observer Javascript™ API is used to detect DOM changes, such as where the following code is injected by surrogate software application 108 into all browser frames associated with web page 102:

```
var target = document; // or document.body // or specific element
// create an observer instance
var observer = new MutationObserver(function(mutations) {
    mutations.forEach(function(mutation) {
        aggregate-sanitize-serialize-send.function(mutation.type);
    });
});
// configuration of the observer:
var config = { attributes: true, childList: true, characterData: true };
observer.observe(target, config);
```

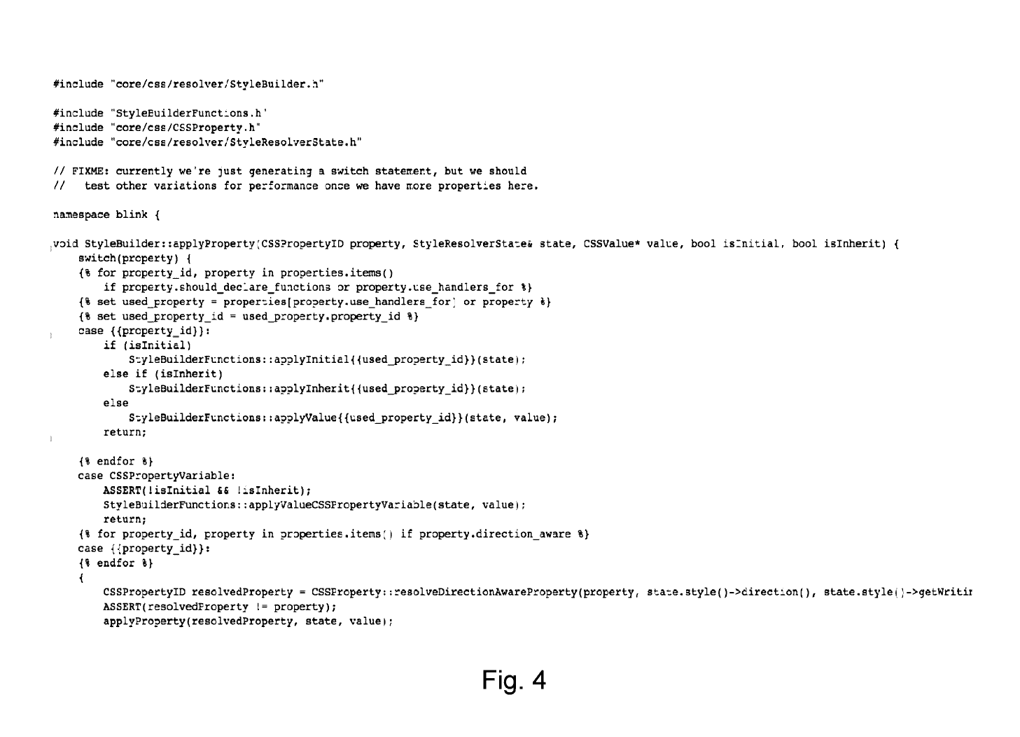

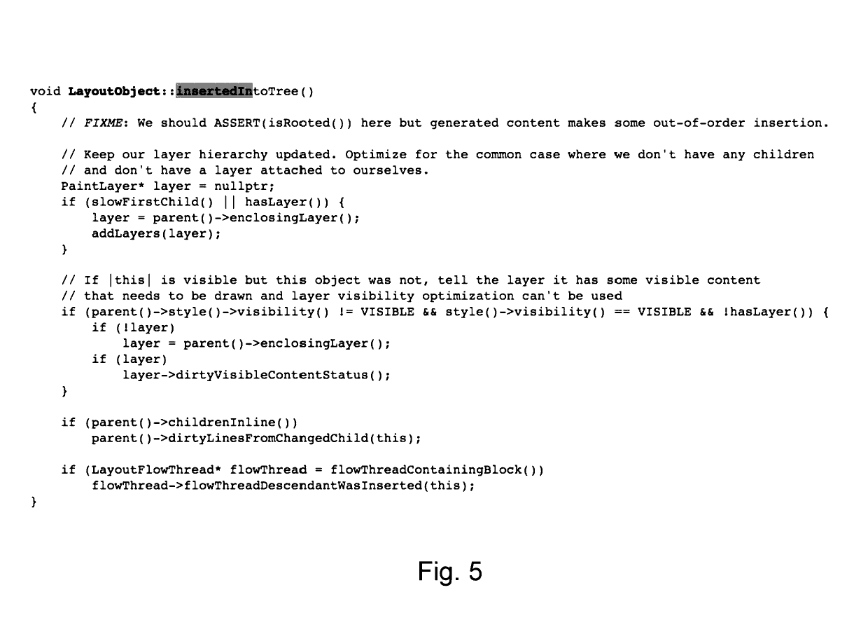

In another embodiment, such as may be used with Google Chromium™, CSSOM changes may be detected by modifying StyleBuilder.cpp methods, such as the applyProperty method, as in the example shown in FIG. 4. Additionally or alternatively, DOM and CSSOM changes may be detected by monitoring render tree modifications, such as by modifying LayoutObject.cpp methods, such as the insertedIntoTree method, as in the example shown in FIG. 5.

Surrogate software application 108 is also preferably configured to identify actions associated with web page 102 whose performance at surrogate software application 108 does not result in changes to models 114, where surrogate-to-client data manager 116 is configured to provide client software application 100 with data and/or instructions associated with such actions, such as in Javascript™, which prompts client software application 100 to effect the results of such actions in association with web page 102. In one embodiment, where such actions include rendering third-party content such as Adobe Flash™, Microsoft Silverlight™, and Oracle Java™ content, surrogate-to-client data manager 116 is configured to provide client software application 100 with results of performing the action at surrogate software application 108, such as by capturing audio and/or visual output of such content at surrogate software application 108, encoding the captured output in compatible formats, such as in H264, PNG, or JPEG formats, and sending the encoded output to client software application 100, which prompts client software application 100 to render the encoded output in association with web page 102, such as using HTML canvas drawing methods. Other types of such actions include URL changes, title changes, plugin crashes, tooltip modifications, favicon modifications, caret position changes, and file downloads, where surrogate-to-client data manager 116 provides client software application 100 with data and/or instructions associated with such actions, such as in Javascript™, which prompts client software application 100 to effect the results of such actions in association with web page 102.

In one embodiment surrogate software application 108 is configured to override various types of functions and in their place provide calculation results and modified HTML instructions to client software application 100. While this may be applied to any type of function, this may be illustrated by the following example which relates to HTML canvas-related functions. Thus, for example, where web page 102 includes the following HTML canvas-related functions:

```
var canvas = document.getElementById(‘myCanvas’);
var context = canvas.getContext(‘2d’);
context.beginPath( );
context.moveTo(calculateX( ), calculateY( ));
context.lineTo(450, 50);
context.stroke( );
function calculateX( ) {
  return 150;
}
function calculateY( ) {
  return 100;
}
```

surrogate software application 108 creates and performs the following override version of the moveTo function as follows:

```
var moveTo = ctx.moveTo;
ctx. moveTo = function ( ) {
    sendToClient(“moveTo”, arguments);
    moveTo.apply(this, arguments);
}
```

where the sendToClient function sends its command and arguments to client software application 100 after its arguments are calculated by surrogate software application 108, such that the argument array is [150,100] and the functions calculateX and calculateY are not invoked at client software application 100. The apply method would then invoke the original moveTo functionality. Client software application 100 then performs the version of the function that it received:
var moveTo=ctx.moveTo;
ctx.moveTo(100,150);

Mediation agent 112 is also preferably configured to detect user interactions with client software application 100, such as where the user interactions are associated with web page 102, and notify surrogate software application 108 of such user interactions, where surrogate software application 108 is configured to process the user interactions in association with web page 102. Such user interactions include, for example, keystrokes, mouse movements, and mouse clicks, which are then performed at surrogate software application 108 in association with web page 102. Thus, in the example described above with reference to FIGS. 2 and 3, when a user mouse-clicks an HTML form ‘submit’ button on web page 102 at client software application 100, which ‘submit’ button belongs to the modified HTML form as shown in FIG. 3 that is configured to prevent client software application 100 from submitting the HTML form directly, mediation agent 112 notifies surrogate software application 108 of the mouse click associated with the ‘submit’ button, whereupon surrogate software application 108 performs the mouse-click on the HTML form ‘submit’ button on web page 102, which ‘submit’ button belongs to the HTML form as shown in FIG. 2. In this manner, the HTML form is submitted by surrogate software application 108 rather than by client software application 100.

User interactions with client software application 100 that are detected by mediation agent 112 at specific display coordinates are preferably performed by surrogate software application 108 at corresponding display coordinates, which may require translation in accordance with conventional techniques if client software application 100 uses a different coordinate system than surrogate software application 108. Thus, in one embodiment, during DOM construction at surrogate software application 108 a different unique identifier attribute (e.g. ‘special_id’) may be appended to each of the various display elements in web page 102, which are then replicated in the DOM maintained by client software application 100 as described hereinabove. When a user mouse-clicks an element at client software application 100, mediation agent 112 detects the user interaction, identifies the unique identifier attribute of that element as well as the display coordinates of the mouse click, and sends the identifier and the coordinates to surrogate software application 108, which then finds its copy of the element having the same unique identifier attribute and performs a mouse-click on it, preferably at corresponding display coordinates, such as by calculating the ratio between the click position inside the element and the display width and height on the display at client software application 100 and at surrogate software application 108. Similarly, web page scrolling may be synchronized between client software application 100 and surrogate software application 108 by ratio calculation using the total height and width of the page (or, if the element on which the scroll is performed is not the top level element in the page, using the total height and width of the scrollable element) and the current X and Y offsets at both client software application 100 and at surrogate software application 108. Scrolling that occurs at surrogate software application 108 is similarly communicated to client software application 100 for synchronization thereat. Display synchronization may likewise be performed in either direction for caret position, including as part of a selection action (by sending the element caret start position and caret start position unique identifier attribute, as well as the caret stop position and caret stop position unique identifier attribute). Text input at client software application 100 is likewise transmitted to surrogate software application 108, and any text changes identified by surrogate software application 108 are communicated to client software application 100, such as a result of validation performed by surrogate software application 108 that is not performed by client software application 100. Element focus may likewise be communicated in either direction.

Any of the elements shown in FIG. 1 are preferably implemented in computer hardware and/or in computer software embodied in a non-transitory, computer-readable medium in accordance with conventional techniques.

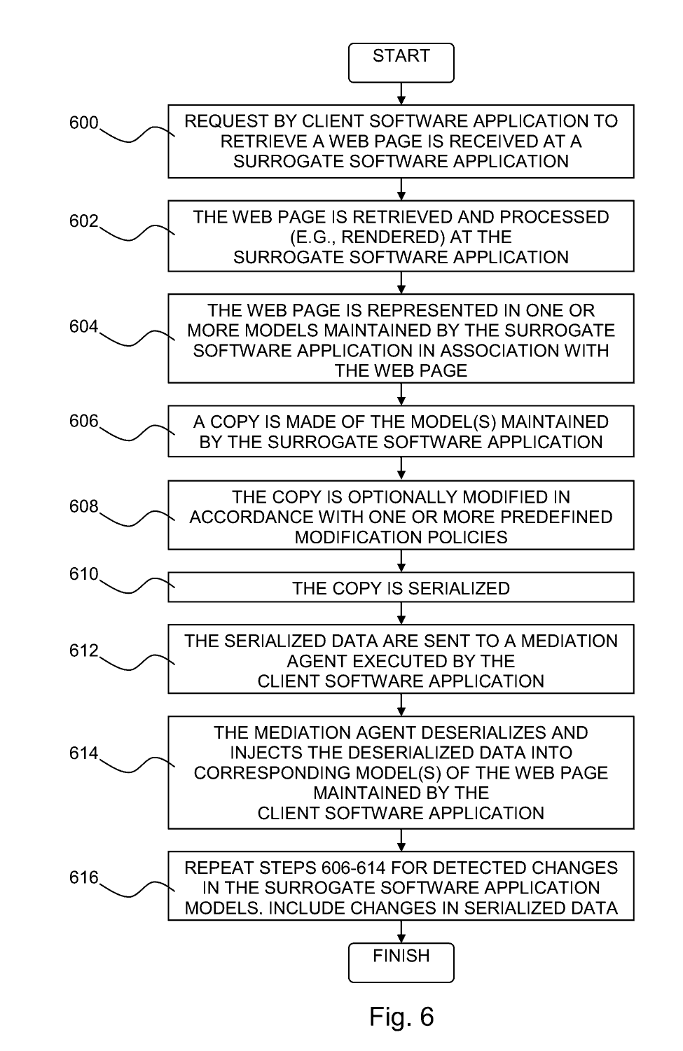

Reference is now made to FIG. 6, which is a simplified flowchart illustration of an exemplary method of operation of the system of FIG. 1, operative in accordance with an embodiment of the invention. In the method of FIG. 6, a request by a client software application to retrieve a web page is received at a surrogate software application (step 600). The web page is retrieved and processed (e.g., rendered) at a surrogate software application (step 602), where the web page is represented in one or more models, such as DOM and CSSOM models, that are maintained by the surrogate software application in association with the web page (step 604). A copy of the model(s) maintained by the surrogate software application, or any portion thereof, is made (step 606). The copy is optionally modified in accordance with one or more predefined modification policies (step 608), and is serialized (step 610). The serialized data are sent to a mediation agent executed by the client software application (step 612). The mediation agent receives the serialized data in association with the web page and deserializes and injects the deserialized data into corresponding model(s) of the web page, where the model(s) is/are maintained by the client software application in association with the web page (step 614). Steps 606-614 are preferably repeated when the surrogate software application detects any changes in the model(s) it maintains (step 616), where the serialized data is at least of the portion of the model(s) that includes the change(s).

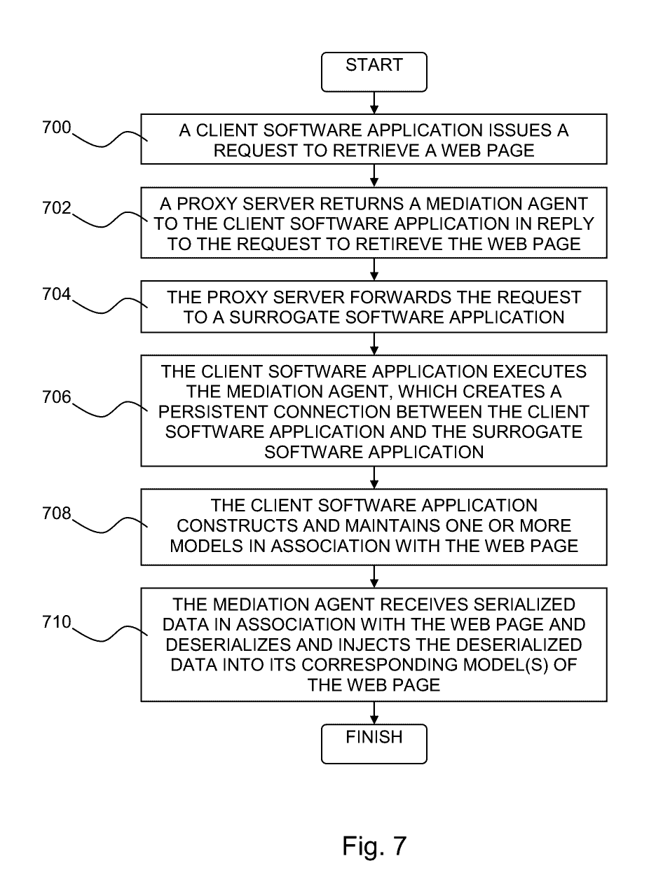

Reference is now made to FIG. 7, which is a simplified flowchart illustration of an exemplary method of operation of the system of FIG. 1, operative in accordance with an embodiment of the invention. In the method of FIG. 7, a client software application issues a request to retrieve a web page (step 700). A proxy server returns a mediation agent to the client software application in reply to the request to retrieve the web page (step 702) and forwards the request to a surrogate software application (step 704). The client software application executes the mediation agent, which creates a persistent connection between the client software application and the surrogate software application (step 706). The client software application constructs and maintains one or more models, such as DOM and CSSOM models, in association with the web page (step 708) that enables it to visually render the webpage. The mediation agent receives serialized data in association with the web page and deserializes and injects the deserialized data into its corresponding model(s) of the web page (step 710).

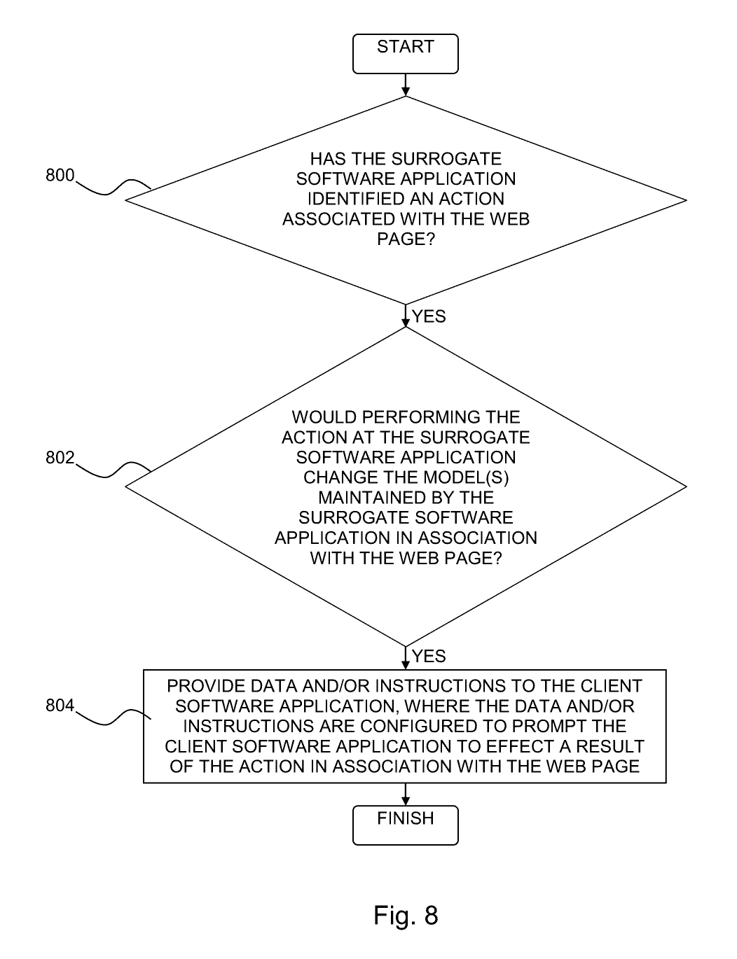

Reference is now made to FIG. 8, which is a simplified flowchart illustration of an exemplary method of operation of the system of FIG. 1, operative in accordance with an embodiment of the invention. In the method of FIG. 8, which may co-operate with any of the methods described herein, if the surrogate software application identifies an action associated with the web page (step 800), and performing the action at the surrogate software application does not change the model(s) maintained by the surrogate software application in association with the web page (step 802), then data and/or instructions are provided to the client software application, where the data and/or instructions are configured to prompt the client software application to effect a result of the action in association with the web page (step 804).

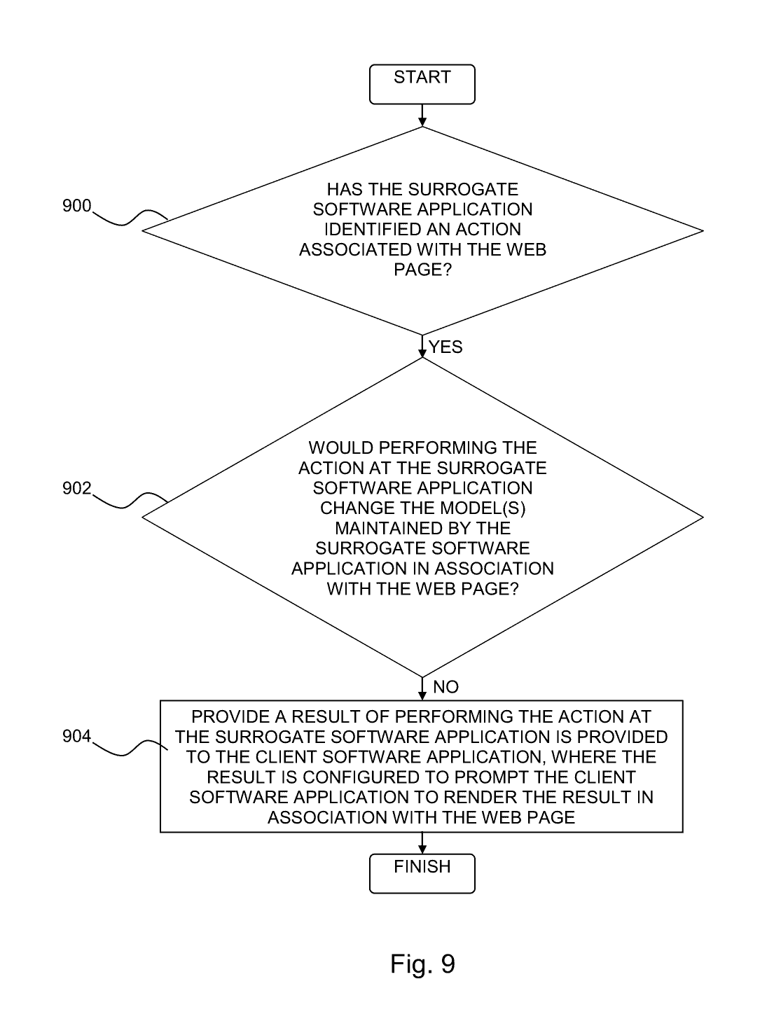

Reference is now made to FIG. 9, which is a simplified flowchart illustration of an exemplary method of operation of the system of FIG. 1, operative in accordance with an embodiment of the invention. In the method of FIG. 9, which may co-operate with any of the methods described herein, if the surrogate software application identifies an action associated with the web page (step 900), and performing the action at the surrogate software application does not change the model(s) maintained by the surrogate software application in association with the web page (step 902), then a result of performing the action at the surrogate software application is provided to the client software application where the result is configured to prompt the client software application to render the result in association with the web page (step 904).

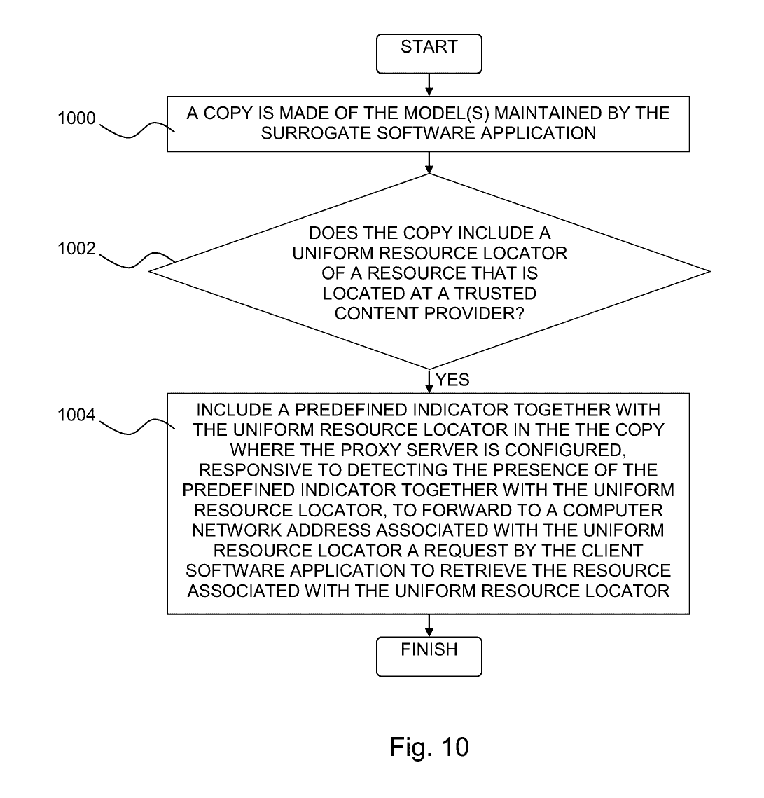

Reference is now made to FIG. 10, which is a simplified flowchart illustration of an exemplary method of operation of the system of FIG. 1, operative in accordance with an embodiment of the invention. In the method of FIG. 10, which may co-operate with any of the methods described herein, a copy of the model(s) maintained by the surrogate software application, or any portion thereof, is made (step 1000). If the copy includes a uniform resource locator of a resource that is located at a trusted content provider (step 1002), then a predefined indicator is included together with the uniform resource locator in the copy where the proxy server is configured, responsive to detecting the presence of the predefined indicator together with the uniform resource locator, to forward to a computer network address associated with the uniform resource locator a request by the client software application to retrieve the resource associated with the uniform resource locator (step 1004).

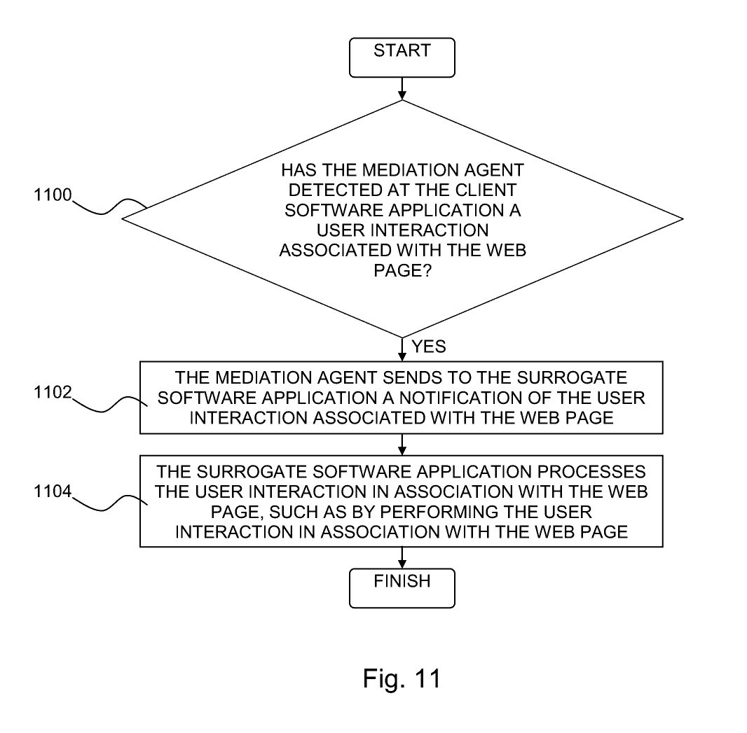

Reference is now made to FIG. 11, which is a simplified flowchart illustration of an exemplary method of operation of the system of FIG. 1, operative in accordance with an embodiment of the invention. In the method of FIG. 11, which may co-operate with any of the methods described herein, if the mediation agent detects at the client software application a user interaction associated with the web page (step 1100) the mediation agent sends to the surrogate software application a notification of the user interaction associated with the web page (step 1102), whereupon the surrogate software application processes the user interaction in association with the web page (step 1104), such as by performing the user interaction in association with the web page.

It is to be appreciated that the term “processor” as used herein is intended to include any processing device, such as, for example, one that includes a CPU (central processing unit) and/or other processing circuitry. It is also to be understood that the term “processor” may refer to more than one processing device and that various elements associated with a processing device may be shared by other processing devices.

The term “memory” as used herein is intended to include memory associated with a processor or CPU, such as, for example, RAM, ROM, a fixed memory device (e.g., hard drive), a removable memory device (e.g., diskette), flash memory, etc. Such memory may be considered a computer readable storage medium.

In addition, the phrase “input/output devices” or “I/O devices” as used herein is intended to include, for example, one or more input devices (e.g., keyboard, mouse, scanner, etc.) for entering data to the processing unit, and/or one or more output devices (e.g., speaker, display, printer, etc.) for presenting results associated with the processing unit.

The descriptions of the various embodiments of the invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A method for processing a web page, the method comprising:
receiving from a client software application a request to retrieve a web page;
processing the web page at a surrogate software application, thereby representing the web page in a model that is maintained by the surrogate software application in association with the web page;
serializing a copy of any portion of the model that is maintained by the surrogate software application, thereby creating serialized data; and
sending the serialized data to a mediation agent executed by the client software application,
wherein the mediation agent is configured to
deserialize the serialized data, thereby creating deserialized data, and
inject the deserialized data into a model that is maintained by the client software application in association with the web page.

2. The method according to claim 1 wherein the processing comprises processing wherein the models are any of document object models and cascading style sheet object models.

3. The method according to claim 1 wherein the processing comprises processing wherein the client software application and the surrogate software application are web browsers.

4. The method according to claim 1 wherein the processing comprises rendering the web page at the surrogate software application.

5. The method according to claim 1 and further comprising modifying, in accordance with a predefined modification policy, the copy of the portion of the model that is maintained by the surrogate software application.

6. The method according to claim 5 wherein:
communications between the client software application and the surrogate software application are mediated by a proxy server that is configured to selectably forward requests by the client software application to the surrogate software application,
the modifying comprises including a predefined indicator together with a uniform resource locator in the copy of the portion of the model that is maintained by the surrogate software application, and
the proxy server is configured, responsive to detecting the presence of the predefined indicator together with the uniform resource locator, to forward to a computer network address associated with the uniform resource locator a request by the client software application to retrieve a resource associated with the uniform resource locator.

7. The method according to claim 1 and further comprising:
identifying a change in the model that is maintained by the surrogate software application in association with the web page; and
performing the serializing and sending wherein the change is included in the serialized data.

8. The method according to claim 1 and further comprising:
identifying, at the surrogate software application, an action associated with the web page, wherein performing the action at the surrogate software application does not change the model that is maintained by the surrogate software application in association with the web page; and
providing to the client software application any of data and instructions associated with the action, thereby prompting the client software application to effect a result of the action in association with the web page.

9. The method according to claim 8 wherein the providing comprises providing to the client software application a result of performing the action at the surrogate software application, thereby prompting the client software application to render the result in association with the web page.

10. The method according to claim 1 and further comprising:
receiving from the mediation agent a notification of a user interaction associated with the web page, wherein the mediation agent is configured to detect the user interaction; and
processing the user interaction at the surrogate software application in association with the web page.

11. The method according to claim 1 wherein the receiving, processing, serializing, and sending are implemented in any of
a) computer hardware, and
b) computer software embodied in a non-transitory, computer-readable medium.

12. A system for processing a web page, the system comprising:
a surrogate software application configured to
receive from a client software application a request to retrieve a web page, and
process the web page, thereby representing the web page in a model that is maintained by the surrogate software application in association with the web page; and
a surrogate-to-client data manager configured to
serialize a copy of any portion of the model that is maintained by the surrogate software application, thereby creating serialized data, and
send the serialized data to the mediation agent executed by the client software application,
wherein the mediation agent is configured to
deserialize the serialized data, thereby creating deserialized data, and
inject the deserialized data into a model that is maintained by the client software application in association with the web page.

13. The system according to claim 12 wherein the models are any of document object models and cascading style sheet object models.

14. The system according to claim 12 wherein the client software application and the surrogate software application are web browsers.

15. The system according to claim 12 wherein the surrogate software application is configured to render the web page.

16. The system according to claim 12 wherein the surrogate-to-client data manager is configured to modify, in accordance with a predefined modification policy, the copy of the portion of the model that is maintained by the surrogate software application.

17. The system according to claim 16 wherein:
communications between the client software application and the surrogate software application are mediated by a proxy server that is configured to selectably forward requests by the client software application to the surrogate software application,
the surrogate-to-client data manager is configured to include a predefined indicator together with a uniform resource locator in the copy of the portion of the model that is maintained by the surrogate software application, and
the proxy server is configured, responsive to detecting the presence of the predefined indicator together with the uniform resource locator, to forward to a computer network address associated with the uniform resource locator a request by the client software application to retrieve a resource associated with the uniform resource locator.

18. The system according to claim 12 wherein the surrogate-to-client data manager is configured to
identify a change in the model that is maintained by the surrogate software application in association with the web page, and
include the change in the serialized data.

19. The system according to claim 12 wherein
the surrogate software application is configured to identify an action associated with the web page, wherein performing the action at the surrogate software application does not change the model that is maintained by the surrogate software application in association with the web page, and
the surrogate-to-client data manager is configured to provide to the client software application any of data and instructions associated with the action, thereby prompting the client software application to effect a result of the action in association with the web page.

20. The system according to claim 19 wherein the surrogate-to-client data manager is configured to provide to the client software application a result of performing the action at the surrogate software application, thereby prompting the client software application to render the result in association with the web page.

21. The system according to claim 12 wherein the surrogate software application is configured to
receive from the mediation agent a notification of a user interaction associated with the web page, wherein the mediation agent is configured to detect the user interaction, and
process the user interaction in association with the web page.

22. The system according to claim 12 wherein the surrogate software application and the surrogate-to-client data manager are implemented in any of
a) computer hardware, and
b) computer software embodied in a non-transitory, computer-readable medium.
